(19) United States
(12) Patent Application Publication
(10) Pub. No.: US 2006/0082946 A1
(43) Pub. Date: Apr. 20, 2006

(54) Power surge protection in an irrigation controller

(75) Inventors: Carlos Alberto Ramirez Duenez, Tijuana (MX); Erick Eduardo Betancourt Ochoa, Tijuana (MX)

Correspondence Address: FITCH EVEN TABIN AND FLANNERY, 120 SOUTH LA SALLE STREET, SUITE 1600, CHICAGO, IL, 60603-3406, US

(73) Assignee: Rain Bird Corporation, Glendora, CA (US)

(21) Appl. No.: 10/965,945

(22) Filed: Oct. 14, 2004

(51) Int. Cl. H02H 5/04

(52) U.S. Cl. 361/111

(57) ABSTRACT

One embodiment is an irrigation control system comprising a controller comprising functional control circuitry; an line coupled to the functional control circuitry; and a surge protection circuit coupled between at least a portion of the line and the functional control circuitry; wherein the surge protection circuit comprises an inductor adapted to be coupled between the functional control circuitry and the line; a first diverter coupled between one end of the inductor and a common line; and a second diverter coupled between another end of the inductor and the common line.

### BACKGROUND OF THE INVENTION

1. Field of the Invention

The present invention relates to surge protection. More specifically, the present invention relates to surge protection for use in irrigation control systems.

2. Discussion of the Related Art

Surge protection for electronic controllers is generally provided by placing a Metal Oxide Varistor (MOV) between the electronic controller and any input or output line that a surge may be induced upon. Surge protection is useful for any induced surge on an input or output line, for example, a surge caused by lightning. U.S. Pat. No. 5,444,611, filed Oct. 28, 1993, issued to Woytowitz et al., shows an irrigation controller with an MOV type surge protection 42. This standard type MOV surge protection can protect for surges up to approximately between 1000 and 1500 Volts. While this may protect the controller from some types of surges, greater protection is needed to ensure the controller will not be damaged by a voltage surge greater than 1500 volts.

### SUMMARY OF THE INVENTION

The different embodiments described herein address the above mentioned needs as well as other needs by providing increased surge protection for a controller.

One embodiment can be characterized as a surge protection circuit for a low voltage system comprising an inductor adapted to be coupled between functional controller circuitry and a line; a first diverter coupled between one end of the inductor and a common line; and a second diverter coupled between another end of the inductor and the common line.

Another embodiment can be characterized as an irrigation control system comprising a controller comprising functional control circuitry; a line coupled to the functional control circuitry; and a surge protection circuit coupled between at least a portion of the line and the functional control circuitry; wherein the surge protection circuit comprises an inductor adapted to be coupled between the functional control circuitry and the line; a first diverter coupled between one end of the inductor and a common line; and a second diverter coupled between another end of the inductor and the common line.

A subsequent embodiment can be characterized as an irrigation control device comprising a printed circuit board; functional irrigation control circuitry formed on the printed circuit board; and a surge protection circuit formed on the printed circuit board and coupling the functional irrigation control circuitry to a line, the surge protection circuit comprising an inductor adapted to be coupled between the functional irrigation control circuitry and the line; a first diverter coupled between one end of the inductor and a common line; and a second diverter coupled between another end of the inductor and the common line.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a block diagram illustrating functional circuitry of an irrigation controller coupled to surge protection circuitry according to one embodiment;

FIG. 2 is a diagram illustrating a controller coupled to a surge protection circuit in accordance with another embodiment;

FIG. 3 is a diagram illustrating different shapes for an etched inductor in accordance with one embodiment;

FIG. 4 is a diagram illustrating functional circuitry of an irrigation controller coupled to surge protection circuitry according to another embodiment; and

FIG. 5 is a diagram illustrating functional circuitry of an irrigation controller coupled to surge protection circuitry according to yet another embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in the limiting sense, but is made merely for the purpose of describing the general principles of the invention. The scope of the invention should be determined with reference to the claims.

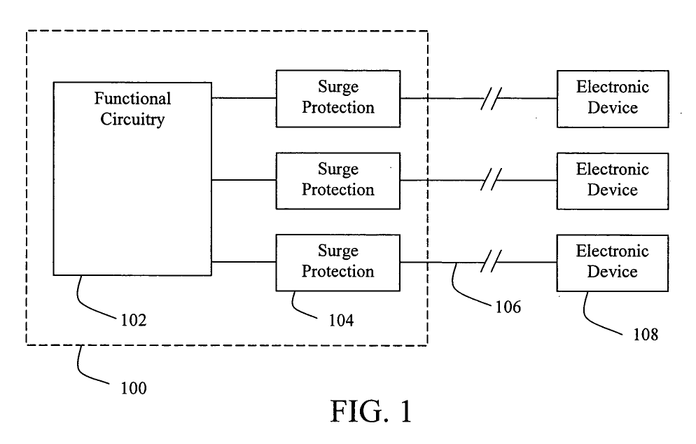

Referring to FIG. 1 a block diagram is shown illustrating functional circuitry of an irrigation controller coupled to surge protection circuitry according to one embodiment. Shown is the irrigation controller 100, the functional circuitry 102, a surge protection circuit 104, a control line 106, and an electronic device 108.

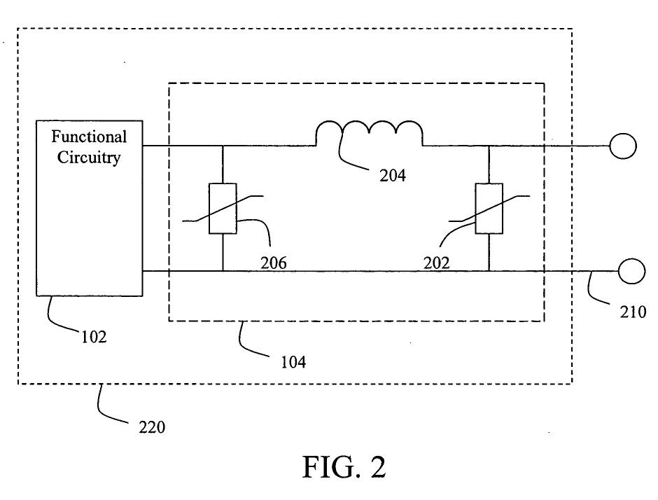

While multiple surge protection circuits, control lines and electronic devices are shown in FIG. 1, only the labeled components (i.e., the surge protection circuit 104, the control line 106, and the electronic device 108) will be described herein in detail as it should be understood that all of the components function in the same manner. Additionally, while the embodiments described herein will be described in terms of an irrigation system, it should be understood that the surge protection circuit 104 can be used with many different types of low voltage systems that may be susceptible to power surges, for example, low voltage lighting systems. Further, it should be understood that while the control line 106 is described in FIG. 1 as a single line, the control line 106 represents both an output line and a common line. Thus, the control line 106 shown in FIG. 1 is actually two lines, such as is shown in FIG. 2 and described herein below. Additionally, in an alternative embodiment, the control line 106 is an input line and a common line.

The irrigation controller 100 is part of a low voltage system that is used to control, for example, solenoid valves located remotely from the irrigation controller 100, each solenoid valve coupled to a water supply line. Opening the solenoid valves allows water to be applied to a specific watering zone. This allows for different watering zones to be watered at different times and for different intervals under control of the irrigation controller 100 that acts as a central processing unit.

The irrigation controller 100 includes the functional circuitry 102 and the surge protection circuits 104. In one embodiment the functional circuitry 102 and surge protection circuits 104 are all place on one printed circuit board within the irrigation controller 100. Alternatively, the functional circuitry 102 and surge protection circuits 104 are implemented on multiple printed circuit boards within the irrigation controller 100.

In yet another alternative embodiment the surge protection circuits 104 are optionally located proximate the irrigation controller 100 instead of being built into the irrigation controller 100. For example, the functional circuitry 102 is implemented within the irrigation controller 100 and the surge protection circuit 104 is implemented adjacent to, but outside of the irrigation controller 100.

The electronic device 108 is, for example, a solenoid valve or a sub controller (also referred to as a satellite controller or a slave controller). Alternatively, the electronic device can be a sensor (e.g., a moisture sensor or temperature sensor). When the electronic device is a sensor, the control line 106 is generally an input line and a common line as the controller is receiving information from the sensor. Many irrigation systems have one central controller that is electrically coupled to multiple solenoid valves and sends control signals to open or close each of the solenoid valves, as described above. In this manner different watering zones are turned off and on by the central controller. In other irrigation systems the central controller is connected to sub controllers. The sub controllers, in combination with the central controller, control the operation of one or more solenoid valves. Surge protection is desired in either type of system. Additionally, the surge protection circuit described herein can be used with sub controllers. Thus, in some embodiments the irrigation controller 100 is a central controller, while in other embodiments, it is a sub controller. Furthermore, the electronic device 108 is a solenoid valve or a sub controller controlled by the central controller in accordance with one embodiment. Thus in one embodiment, the control line is an input line and a common line connected to the central controller or the sub controller. In another embodiment, the control line is an output line and a common line connected to the central controller or the sub controller.

The surge protection circuit 104 prevents surges (for example, a surge induced by lightning) from damaging the functional circuitry 102 of the irrigation controller 100. In a typical irrigation system, the control line 106 extends great distances (for example, in many systems the control line 106 extends for 2,500 feet). In one embodiment when the irrigation controller 100 is used, for example, on a golf course, the control line 106 for each electronic device 108 (e.g., a solenoid valve) extends to each solenoid valve that controls water flow to each different watering area. Therefore, there is a fairly large amount of distance of control line 106 that is susceptible to being struck by lightning or having lightning strike nearby the control line 106 such that a surge is induced on the control line 106. A lightning strike on or near one or more of the plurality of control lines will introduce a surge on the control line. The surge is generally a very high voltage, short duration pulse. Thus, if there is not sufficient surge protection at the irrigation controller 100, the functional circuitry 102 of the irrigation controller 100 will be damaged.

Referring next to FIG. 2 a diagram is shown illustrating a controller coupled to a surge protection circuit in accordance with another embodiment. The surge protection circuit 104 is one embodiment of the surge protection circuit 104 shown in FIG. 1. Shown is the functional circuitry 102 of a controller, the surge protection circuit 104, a first diverter device 202, an inductor 204, a second diverter device 204, an output line 208 (which is generically referred to as a voltage line or a line), a common line 210, and a printed circuit board 220.

The inductor 204 is coupled in series between the functional circuitry 102 of the controller and the output line 208. The first diverter 202 is coupled between the output line 208 and the common line 210 at one end of the inductor 204. The second diverter 206 is coupled between a second end of the inductor and the common line 210.

The surge protection circuit 104 includes the first diverter device 202, the inductor 204, and the second diverter device 206. The surge protection circuit 104 protects the functional circuitry 102 of the controller from surges that occur on the output line 208. For example, if lightning strikes the output line 208 or near the output line 208, a surge of electricity can be induced on the output line 208. The first diverter device 202 in combination with the inductor 204 will divert much of the energy from the surge. The inductor 204 causes a delay in the energy from the surge giving the first diverter device 202 enough time to activate and divert much of the energy from the surge. Any remaining energy that passes through the inductor 204 will then be diverted by the second diverter device 206. This configuration is capable of diverting surges up to, for example, 6000 volts or higher.

In one embodiment, the first diverter device 202 has a much greater shunting capability than the second diverter device 206. As described above, the first diverter device 202 receives all of the energy from the surge and will divert as much energy as it is capable of diverting. The second diverter device 206 will then receive much less energy that needs to be diverted and thus does not need to have the same shunting capability as the first diverter device 202.

In operation when the first diverter device 202 is diverting energy it acts as a very small resistance for a very short period of time (for example, microseconds). As the energy increases, the voltage between the terminals of the first diverter device 202 (which in one embodiment is an MOV) increases. The voltage between the terminals of the first diverter device 202 will eventually reach a maximum and thus the energy will need to be shunted again. Thus, energy that is not shunted by the first diverter device 202 will be shunted by the second diverter device 206.

The first diverter device 202 and the second diverter device 206 are in one embodiment metal oxide varistors (MOV). Optionally, however, the first diverter device 202 and the second diverter device 206 are other types of diverters, for example, a gas tube arrester, a neon lamp, a spark gap, a semi-conductor based surge arrestor, and a Zener diode. Additionally, the first diverter device 202 and the second diverter device 206 do not need to be the same type of diverter, for example, the first diverter device 202 is a gas tube and the second diverter 206 is a MOV in one embodiment.

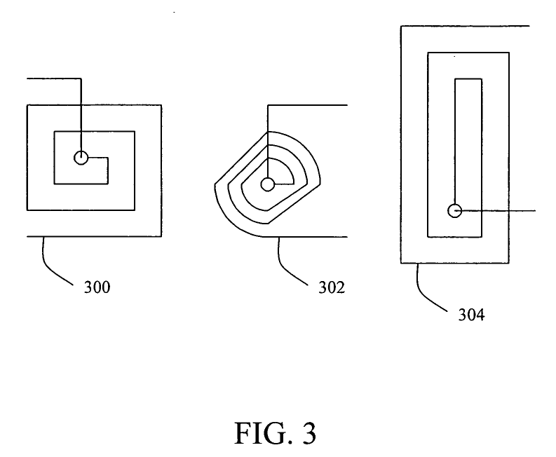

The inductor 204 is either a discrete component or an etched inductor on a printed circuit board. An etched inductor will be further described below with reference to FIGS. 3.

The output line 208 is, in one embodiment, a 24 Volt control line for an irrigation system. The output line 208 provides power to, for example, a solenoid valve, a sub-controller, or a sensor device such as a moisture sensor or temperature sensor. Irrigation systems, usually include at least two different solenoid valves that control different watering stations. Each solenoid valve restricts the flow of water to one or more sprinkler heads until the solenoid valve is activated. In an irrigation system, the output line 208 is generally an insulated copper wire that is connected to a solenoid valve. Additionally, returning from the solenoid valve is the common line 210. Therefore, a pair of copper wires is connected to each solenoid valve that is connected to the irrigation controller.

Additionally, while FIG. 2 is described as having the output line 208, the output line 208 can also be an input line for a controller or sub controller. Further, the output line and the input line can also both be generically referred to as voltage lines or lines.

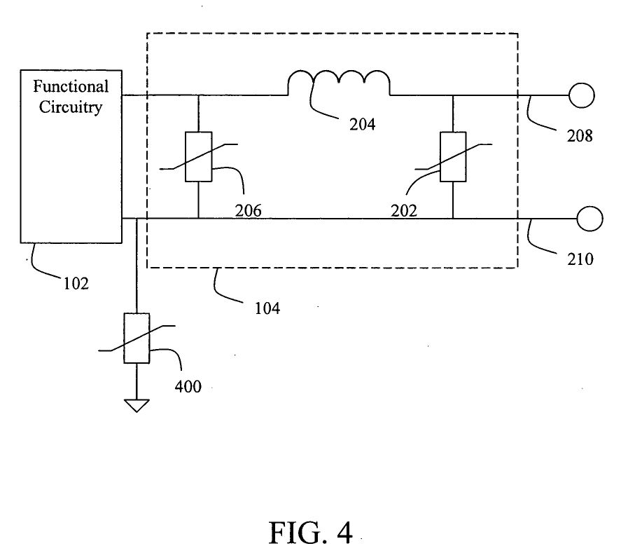

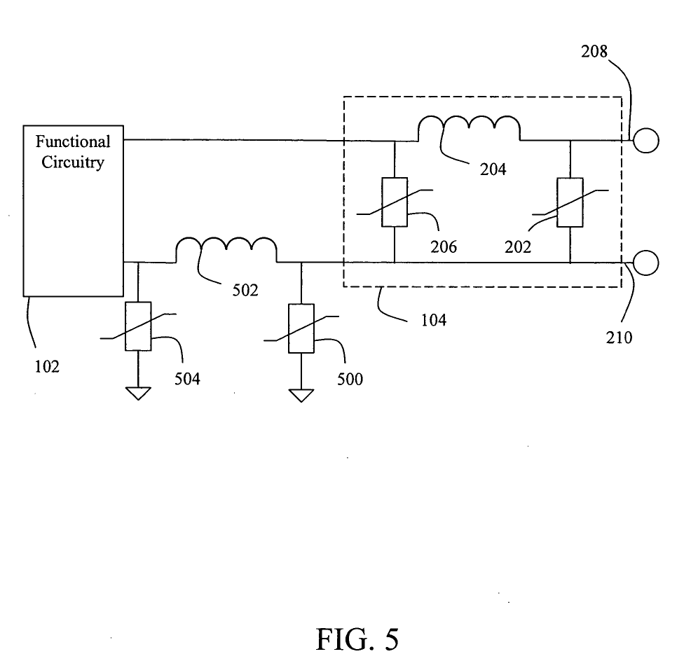

The common line 210 can be connected directly to ground or can be coupled to ground through surge protection circuit (such as is shown in FIGS. 4 and 5).

The functional circuitry 102 and the surge protection circuits 104 are implemented, in one embodiment on the printed circuit board 220. Advantageously, this provides for a compact and planar use of space within the irrigation controller. Additionally, the utilization of a single printed circuit board 220 eliminates the need for some discrete components (which can increase the cost of the irrigation controller). In alternative embodiments the functional circuitry 102 and the surge protection circuits 104 are implemented on more than one printed circuit board within the irrigation controller.

Referring now to FIG. 3 a diagram is shown illustrating different shapes for an etched inductor in accordance with one embodiment. Shown is a square shaped etched inductor 300, an elliptical shaped etched inductor 302 and a rectangular shaped etched inductor 304.

As described above, with reference to FIG. 2, in one embodiment the inductor 204 is an etched inductor. The etched inductor is formed by placing traces, for example copper traces, on a printed circuit board or a flex circuit board. The coil configuration of the traces forms an inductor directly on the circuit board. Advantageously, this provides an inexpensive and easy to manufacture way to place the inductor within the surge protection circuit 104.

Shown are three different shapes for the inductor 204, however, many different shapes can be used while still being able to form an etched inductor. Advantageously, the etched inductor also provides for an easy mechanism to change the value of the inductance. For example, adding additional turns or increasing the thickness or weight of the trace will increase the inductance of the etched inductor. This allows for easy adjustment of the value of the inductor such that the surge protection circuit 104 (shown in FIG. 2) can be adjusted to increase the effectiveness of the surge protection. While three turns are shown in each of the examples of FIG. 3, many different numbers of turns can be utilized depending upon the space available on the printed circuit board. For example, in one embodiment the etched inductor includes up to 10 turns. Additionally, the etched inductor can be formed on one or more layers of a printed circuit board. Using vias in the printed circuit board to connect the different layers the inductor can be formed on more than one layer of the printed circuit board.

Referring to FIG. 4 a diagram is shown illustrating functional circuitry of an irrigation controller coupled to surge protection circuitry according to another embodiment. Shown is the functional circuitry 102 of a controller, the surge protection circuit 104, the first diverter device 202, the inductor 204, the second diverter device 204, the output line 208, the common line 210 and a third diverter device 400. The figure shown in FIG. 4 is the same as FIG. 2 however, the third diverter device 400 is additionally shown.

The inductor 204 is coupled in series between the functional circuitry 102 of the controller and the output line 208. The first diverter 202 is coupled between the output line 208 and the common line 210 at one end of the inductor 204. The second diverter 206 is coupled between a second end of the inductor and the common line 210. The third diverter device 400 is coupled between the common line 210 and ground.

The third diverter device 400 provides surge protection for the functional circuitry 102 of the irrigation controller for a surge that occurs on the common line 210. A large surge such as can be found on the output line 208 (described above) is not expected on the common line 210. Therefore, for many applications a single diverter on the common line 210 provides a sufficient shunt against a lightning induced surge.

Referring now to FIG. 5 a diagram is shown illustrating functional circuitry of an irrigation controller coupled to surge protection circuitry according to yet another embodiment. Shown is the functional circuitry 102 of a controller, the surge protection circuit 104, the first diverter device 202, the inductor 204, the second diverter device 204, the output line 208, the common line 210 and a fourth diverter device 500, a second inductor 502 and a fifth diverter device 504. The illustration of FIG. 5 is similar to that of FIG. 4 however, the third diverter device 400 is replaced by the fourth diverter device 500, the second inductor 502 and the fifth diverter device 504.

The inductor 204 is coupled in series between the functional circuitry 102 of the controller and the output line 208. The first diverter 202 is coupled between the output line 208 and the common line 210 at one end of the inductor 204. The second diverter 206 is coupled between a second end of the inductor and the common line 210. The second inductor 502 is coupled in series between the common line 210 and the functional circuitry 102 of the irrigation controller. The fourth diverter device 500 is coupled between the common line 210 and ground at one end of the inductor. The fifth diverter device 504 is coupled between a second end of the inductor 502 and ground.

The fourth diverter device 500, the second inductor 502 and the fifth diverter device 504 provide surge protection for the functional circuitry 102 of the irrigation controller for a surge that occurs on the common line 210. The fourth diverter device 500, the second inductor 502 and the fifth diverter device 504 function the same as the surge protection circuit 104 described above. While the third diverter of FIG. 4 is sufficient for many applications, the embodiment shown in FIG. 5 provides additional protection for the functional circuitry 102 from a surge induced on the common line 210.

In one embodiment for the circuits shown in FIGS. 4 and 5, the surge protection circuitry 104, the functional circuitry 102 and either the third diverter 400 or the fourth diverter device 500, the second inductor 502 and the fifth diverter device 504 are all implemented on a single printed circuit board.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A surge protection circuit for a low voltage system comprising:
an inductor adapted to be coupled between functional controller circuitry and a line;
a first diverter coupled between one end of the inductor and a common line; and
a second diverter coupled between another end of the inductor and the common line.

2. The surge protection circuit of claim 1 wherein the first diverter comprises a device selected from the group consisting of a Metal Oxide Varistor, a gas tube arrester, a neon lamp, a spark gap, a semi-conductor based surge arrestor, and a Zener diode.

3. The surge protection circuit of claim 2 wherein the second diverter comprises a device selected from the group consisting of a Metal Oxide Varistor, a gas tube arrester, a neon lamp, a spark gap, a semi-conductor based surge arrestor, and a Zener diode.

4. The surge protection circuit of claim 1 wherein the inductor is a discrete inductor.

5. The surge protection circuit of claim 1 wherein the inductor is an etched inductor formed on a printed circuit board.

6. The surge protection circuit of claim 5 wherein the first diverter device, the second diverter device and the inductor are formed on the printed circuit board.

7. The surge protection circuit of claim 5 wherein the etched inductor is formed upon multiple layers of the printed circuit board.

8. The surge protection circuit of claim 7 wherein the line is coupled to a solenoid valve of an irrigation control system.

9. The surge protection circuit of claim 7 wherein the line is coupled to a sub controller of an irrigation control system.

10. The surge protection circuit of claim 1 further comprising a surge protection circuit coupled between the common line and ground.

11. The surge protection circuit of claim 10 wherein the surge protection circuit comprises a third diverter device.

12. The surge protection circuit of claim 10 wherein the surge protection circuit comprises:
a second inductor adapted to be coupled between the functional controller circuitry and the common line;
a third diverter coupled between one end of the second inductor and ground; and
a fourth diverter coupled between another end of the second inductor and the ground.

13. The surge protection circuit of claim 1 wherein the line is selected from the group consisting of an input line and an output line.

14. An irrigation control system comprising:
a controller comprising:
functional control circuitry;
a line coupled to the functional control circuitry; and
a surge protection circuit coupled between at least a portion of the line and the functional control circuitry;
wherein the surge protection circuit comprises:
an inductor adapted to be coupled between the functional control circuitry and the line;
a first diverter coupled between one end of the inductor and a common line; and
a second diverter coupled between another end of the inductor and the common line.

15. The irrigation control system of claim 14 wherein the first diverter comprises a device selected from the group consisting of a Metal Oxide Varistor, a gas tube arrester, a neon lamp, a spark gap, a semi-conductor based surge arrestor, and a Zener diode.

16. The irrigation control system of claim 15 wherein the second diverter comprises a device selected from the group consisting of a Metal Oxide Varistor, a gas tube arrester, a neon lamp, a spark gap, a semi-conductor based surge arrestor, and a Zener diode.

17. The irrigation control system of claim 14 wherein the inductor is a discrete inductor.

18. The irrigation control system of claim 14 wherein the inductor is an etched inductor formed on a printed circuit board.

19. The irrigation control system of claim 18 wherein the etched inductor is formed upon multiple layers of the printed circuit board.

20. The irrigation control system of claim 14 wherein the line is coupled to a solenoid valve of an irrigation system.

21. The irrigation control system of claim 14 wherein the line is coupled to a sub controller of an irrigation system.

22. The irrigation control system of claim 14 further comprising a second surge protection circuit coupled between the common line and ground.

23. The irrigation control system of claim 22 wherein the second surge protection circuit comprises a third diverter device.

24. The irrigation control system of claim 22 wherein the second surge protection circuit comprises:
a second inductor adapted to be coupled between the functional control circuitry and the common line;
a third diverter coupled between one end of the second inductor and ground; and
a fourth diverter coupled between another end of the second inductor and the ground.

25. The irrigation control system of claim 14 wherein the line is selected from the group consisting of an input line and an output line.

26. An irrigation control device comprising:
a printed circuit board;
functional irrigation control circuitry formed on the printed circuit board; and
a surge protection circuit formed on the printed circuit board and coupling the functional irrigation control circuitry to a line, the surge protection circuit comprising:
an inductor adapted to be coupled between the functional irrigation control circuitry and the line;
a first diverter coupled between one end of the inductor and a common line; and
a second diverter coupled between another end of the inductor and the common line.

27. The irrigation control device of claim 26 further comprising a second surge protection circuit formed on the printed circuit board, the second surge protection circuit coupled between the common line and ground.

28. The irrigation control device of claim 27 wherein the second surge protection circuit comprises a third diverter device.

29. The irrigation control device of claim 27 wherein the second surge protection circuit comprises:
a second inductor adapted to be coupled between the functional control circuitry and the common line;
a third diverter coupled between one end of the second inductor and ground; and
a fourth diverter coupled between another end of the second inductor and the ground.

30. The irrigation control device of claim 26 wherein the line is selected from the group consisting of an input line and an output line.
